(19) United States
(12) Patent Application Publication
(10) Pub. No.: US 2023/0014341 A1
(43) Pub. Date: Jan. 19, 2023

(54) A SENSOR FOR MONITORING FLOTATION RECOVERY

(71) Applicant: THE UNIVERSITY OF QUEENSLAND, St Lucia, Queensland (AU)

(72) Inventors: Liguang WANG, St Lucia (AU); Hangil PARK, St Lucia (AU)

(21) Appl. No.: 17/757,596

(22) PCT Filed: Dec. 17, 2020
(86) PCT No.: PCT/AU2020/051385

§ 371 Date: Jun. 17, 2022

(30) Foreign Application Priority Data
Dec. 19, 2019 (AU) 2019904830

(51) Int. Cl. B03D 1/02; B03D 1/14; G01L 5/00; G01L 1/22; G01N 11/14

(52) U.S. Cl. CPC B03D 1/028; B03D 1/1462; G01L 1/22; G01L 5/0038; G01N 11/14; B03D 2203/08

(57) ABSTRACT

An apparatus (20) for monitoring flotation performance apparatus comprises an arm (21) having a paddle (22) attached at one end. The apparatus (20) forms a sensor to monitor real-time flotation performance by measuring the drag exerted by the overflowing froth onto a cantilever beam arm. The strain exerted on the beam or arm can be directly correlated to the efficiency of the froth flotation process. Methods for monitoring and controlling a froth flotation process and a method to determine ash content in coal undergoing flotation are also described

### TECHNICAL FIELD

The present invention relates to a sensor for monitoring flotation recovery. The present invention also relates to a method for monitoring flotation and a method for controlling flotation.

### BACKGROUND ART

Minerals and coal need to be beneficiated from ore/concentrates/crudes before being sold into the market. Among the present beneficiation methods, froth flotation is widely employed for fine and ultrafine size fractions of ore. Froth flotation is a physicochemical separation process utilising air bubbles to selectively pick up certain minerals and transport the aggregate to the upper froth zone while leaving other minerals behind in the lower pulp phase. Collectors, which are chemicals that assist in adhering the valuable products to the air bubbles, are typically added to the pulp to increase yield. Froth flotation is a widely practised process that is well known to person skilled in the art.

FIG. 1 shows a schematic diagram of a conventional froth flotation process. The flotation process is conducted in a tank 10. An impeller 11 mounted to a shaft 12 is rotated by a motor 13. A pulp or slurry 14 is added via feed port 14a to the tank 10. The impeller also has a number of holes in it such that air that is supplied by air supply 15 is injected into the pulp or slurry to form bubbles. The bubbles collect minerals or coal as they float to the surface and form a froth layer 16. Unwanted material sinks to the bottom of the tank 10 and is removed with the tailings 17. The froth layer 16 overflows a weir or lip 18 at the top of the tank 10 and flows into a concentrate launder 19.

Monitoring and diagnosis of flotation performance is increasingly more dependent on real-time measurements than plant personnel, especially in remote areas where most mining and processing operations are located. For instance, BHP, the world’s largest mining company, runs an integrated remote operation centre in Brisbane for controlling its coal operations in Central Queensland and New South Wales.

Gas hold-up measurement techniques are widely used in the industry for measurement of froth flotation efficiency. Other methods developed, such as froth stability columns, electrical impedance and machine vision techniques have been employed with very limited success. Air recovery techniques are known but not widely used. The air recovery system for monitoring and controlling flotation is yet to find widespread industrial application as sophisticated machine vision instruments and specialist software are required for data collection and analysis. On the other hand, the gas hold-up method suffers from limitations in obtaining accurate measurements.

There is a need to develop a low cost and accurate diagnostic tool to monitor the flotation performance of froth flotation operations in real-time, which will provide the prospects of enabling instant control of the operational variables to maximise and maintain flotation efficiency.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a sensor for monitoring flotation performance and to a method for monitoring flotation performance, which may at least partially overcome at least one of the abovementioned disadvantages or provide the consumer with a useful or commercial choice.

With the foregoing in view, the present invention in one form, resides broadly in an apparatus for monitoring flotation performance, the apparatus comprising a drag member positionable to allow froth of a froth flotation operation to contact the drag member, and a sensor for determining a drag force or a parameter associated with the drag force provided on the drag member by the froth.

In one embodiment, the froth contacts the drag member and the froth flows around and past the sensor. In one embodiment, the drag member is positioned such that it is positioned in a flow of froth overflowing a froth flotation vessel.

In one embodiment, the sensor provides a signal associated with the drag force provided on the drag member. In one embodiment, the signal is provided to a monitoring system or a control system. The monitoring system or control system may be located remotely to the site of the flotation operation.

In one embodiment, the drag member comprises an arm. As the froth flows around and past the drag member, the drag force applied to the drag member by the froth causes deflection of the arm. The deflection of the arm has been found to be directly correlated to the efficiency of the froth flotation process. In one embodiment, the arm comprises a cantilever arm being fixed at one end. The arm may comprise a beam.

In one embodiment, the sensor senses deflection of the arm. In one embodiment, the sensor comprises one or more strain gauges attached to the arm. In another embodiment, the sensor comprises a deflection measurement sensor that measures deflection of the sensor. In another embodiment, the sensor comprises a visual sensor that uses image processing technology to measure deflection of the arm, or a laser-based optical deflection method with high-sensitivity position-sensitive detector.

In one embodiment, the sensor generates an electrical signal in response to deflection of the arm. The electrical signal or the value of the electrical signal may be transmitted to the control system wirelessly or through a wired communications network.

In one embodiment, the sensor comprises a strain gauge mounted to one side of the arm, or the sensor comprises at least one strain gauge mounted on one side of the arm and at least one other strain gauge mounted on the other side of the arm. The drag force of the froth flowing past and around the drag member leads to a deflection of the arm and induces a positive strain (extension) on the side facing the froth and a negative strain (compression) on the other side of the arm. The difference in strain exerted on the sensors on either side of the arm by the froth can be directly correlated to efficiency of the froth flotation process.

In one embodiment, the drag member comprises a paddle or a plate mounted to an arm. The paddle or the plate may be of a square or rectangular shape, although it will be appreciated that other shapes can be provided. The paddle or the plate provides a larger contact area between the froth and the paddle of the plate, which results in the froth applying a larger force to the paddle of the plate. This is believed to provide greater accuracy of measurement of the drag force. The size of the paddle or plate may vary considerably, but the present inventors have found that a square panel having dimensions of 100 mm x 100 mm provides satisfactory operation. It will, of course, be appreciated that the paddle or plate should not be considered to be limited to this particular size.

In one embodiment, the paddle or plate is mounted a short distance above an overflow lip of the flotation vessel. Froth from the flotation operation will form a froth layer that extends above the overflow lip. The froth flows outwardly over the overflow lip. The outwardly flowing froth applies a drag force to the drag member which, in turn, is measured, at least indirectly, by the sensor.

In one embodiment, the drag member comprises a paddle or a plate mounted to formed with an arm, the paddle of the plate being positioned such that it is located such that a part of the paddle or plate is in contact with the froth and the remainder of the paddle or plate is located above the froth layer.

In one embodiment, the drag member is mounted in a fixed location relative to the vessel of the flotation operation. In one embodiment, the drag member comprises a paddle or plate mounted to or formed with an arm, the arm being mounted at an upper end to a fixed location, the paddle or plate being located at a lower end of the drag member. In this embodiment, the sensor can have its working components, electrical connections and communication components located above the froth layer. This may increase the reliability as overflowing froth is unlikely to come into contact with those components. However, it will be appreciated that the particular orientation of the drag member can vary from this orientation.

In a second aspect, the present invention provides a method for monitoring a froth flotation operation, the method comprising mounting a drag member such that froth in the froth flotation operation applies a drag force to the drag member, and measuring the drag force or determining a parameter associated with the drag force applied to the drag member.

In one embodiment, the method further comprises transmitting a signal indicative of the drag force or indicative of the parameter associated with the drag force to a control system or monitoring system. In one embodiment, the signal is transmitted to a control system or monitoring system that is located remotely to the site of the froth flotation operation.

In one embodiment, the method further comprises correlating the drag force or the parameter associated with the drag force with flotation performance.

In one embodiment, the method comprises real-time monitoring of the froth flotation operation.

In one embodiment, one or more strain gauges are used to measure the drag force applied by the froth to the drag member and a signal or signals generated by the one or more strain gauges correlate to performance of the froth flotation operation. Other sensors that can also be used to measure the drag force or determine a parameter indicative of the drag force applied to the drag member are as described with reference to the first aspect of the present invention.

In one embodiment, the method comprises providing a drag member comprising a paddle or a plate mounted to or formed with an arm, mounting the drag member in a fixed position such that the paddle or plate is located partly within a froth layer, wherein the froth overflowing the lip applies a drag force to the paddle or plate. In one embodiment, the drag member is mounted in a fixed position such that the paddle or plate is located partly within a froth layer overflowing an overflow lip of a froth flotation vessel.

In one embodiment, the paddle or plate is mounted such that an upper edge is positioned above the froth layer and a lower edge is positioned within the froth layer.

In one embodiment, the paddle is located such that it has a lower edge located above the overflow lip and the arm extends upwardly from the paddle or plate. The upper end of the arm may be fixed, for example, by mounting the upper end to a fixed superstructure.

In one embodiment, one or more drag members may be provided on each flotation vessel. In one embodiment, a single drag member is provided on a flotation vessel. In another embodiment, two or more drag members may be provided on each flotation vessel, each drag member having a sensor to determine the drag force applied thereto or to measure a parameter associated with the drag force. Although optimisation tests have not yet been conducted by the present inventors, the present inventors believe that providing 2 drag members for each flotation vessel will be sufficient to provide very good accuracy in monitoring of flotation performance.

In one embodiment, the method of the second aspect of the present invention comprises measuring the drag force or determining a parameter associated with the drag force applied to the drag member at a certain time, taking a sample of the froth at that certain time and analysing the sample of the froth at that certain time to determine froth flotation performance at that certain time, and repeating those tests at spaced times, and obtaining a correlation between the drag force or the parameter associated with the drag force and froth flotation performance. In this manner, the drag force or the parameter associated with the drag force can be used to infer and monitor the froth flotation performance.

In a third aspect, the present invention provides a method for controlling a froth flotation operation, the method comprising mounting a drag member such that froth in the froth flotation operation applies a drag force to the drag member, and measuring the drag force or determining a parameter associated with the drag force applied to the drag member, correlating the drag force or the parameter associated with the drag force with flotation performance and adjusting operation of the froth flotation operation in response to changes in flotation performance.

In one embodiment, the method for controlling the froth flotation operation operates in real-time. In one embodiment, the method for controlling the froth flotation operation comprises adjusting one or more of the following operational parameters in response to changes in flotation performance: amount of collector, amount of frother, pulp level, pulp density, agitation speed, rate of air injection, wash water rate, depressor dosage, activator dosage, volumetric flow rate of the flotation feed and pH, especially for metalliferous minerals.

In one embodiment, the method for controlling the froth flotation operation is conducted automatically in accordance with a control system. In one embodiment, the flotation operation is monitored from a remote location.

The present inventors have also found that the sensor of the present invention can be used to determine ash content in coal that is being subjected to flotation.

According to a further aspect, the present invention provides a method for determining ash content of coal in a flotation process, the method comprising mounting a drag member such that froth in the froth flotation operation applies a drag force to the drag member, and measuring the drag force or determining a parameter associated with the drag force applied to the drag member, and calculating an ash content from the measured drag force or from the parameter associated with the drag force.

In one embodiment, the method of this aspect of the present invention comprises taking a sample of coal in the froth, measuring the drag force or determining a parameter associated with the drag force applied to the drag member at the time that the sample was taken, repeating these steps over a period of time, analysing the samples for ash content in the coal and determining a correlation between the analysed ash content and the measured drag force or parameter, and subsequently determining ash content by measuring the drag force or determining a parameter associated with the drag force applied to the drag member and using the correlation to determine the ash content associated with the measured drag force or parameter. The other operating conditions in the flotation process should be held substantially constant during these measurements to obtain a suitably accurate correlation. More preferably, the other operating conditions in the flotation process are held at or near normal operating conditions during these measurements.

In this aspect of the present invention, the method allows for real-time monitoring of the ash content in the coal feed in the flotation operation. In some embodiments, other operation conditions in the flotation operation are held almost constant. It has been found that more reliable ash measurements can be obtained when the other operating conditions are held almost constant with the main variable being ash content of the coal being fed to the flotation operation. More preferably, the other operating conditions in the flotation process are held at or near normal operating conditions in order to obtain accurate ash content determinations.

The present invention provides a simple and robust device that enables real-time monitoring of froth flotation performance. As monitoring of froth flotation performance can take place in real time, remote monitoring of the flotation operation is feasible. The apparatus for monitoring flotation performance in accordance with the present invention is inexpensive and can be easily retrofitted to existing froth flotation operations.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 shows a schematic view of a conventional flotation process (FIG. 1 is taken from https://www.911metallurgist.com/blog/froth-flotation-process);

FIG. 2 shows a schematic view of an apparatus for monitoring flotation performance in accordance with one embodiment of the present invention;

FIG. 3 shows a side schematic view of the apparatus shown in FIG. 2 being used to monitor a froth flotation operation;

FIG. 4 shows typical signal output, strain (ε), of a sensor in accordance with an embodiment of the present invention with and without load;

FIG. 5 shows correlation between yield and the output from a sensor in accordance with an embodiment of the present invention over all the operating conditions tested;

FIG. 6 shows correlation between yield and the output from a gas holdup measurement with differential pressure meter (“System GH”);

FIG. 7 shows correlation between combustible recovery and the output from a sensor in accordance with an embodiment of the present invention;

FIG. 8 shows correlation between combustible recovery and the output from the System GH over all the operating conditions tested;

FIG. 9 shows correlation between flotation yield and the output from a sensor in accordance with an embodiment of the present invention at normal operating conditions (Frother dosage > 170 mL/min and aeration rate = 1700 m3/hr):

FIG. 10 shows correlation between flotation yield and the output from the System GH at normal operating conditions (Frother dosage > 170 mL/min and aeration rate = 1700 m³/hr);

FIG. 11 shows correlation between combustible recovery and the output from a sensor in accordance with an embodiment of the present invention at the normal operating conditions;

FIG. 12 shows correlation between combustible recovery and the output from the System GH at the normal operating conditions;

FIG. 13 shows correlation between feed ash content and the output from a sensor in accordance with an embodiment of the present invention at the normal operating conditions;

FIG. 14 shows correlation between feed ash content and the output from the System GH at the normal operating conditions.;

### DESCRIPTION OF EMBODIMENTS

The skilled person will appreciate the drawings have been provided for the purposes of illustrating preferred embodiments of the present invention. Therefore, it will be understood that the present invention should not be considered to be limited solely to the features as shown in the attached drawings.

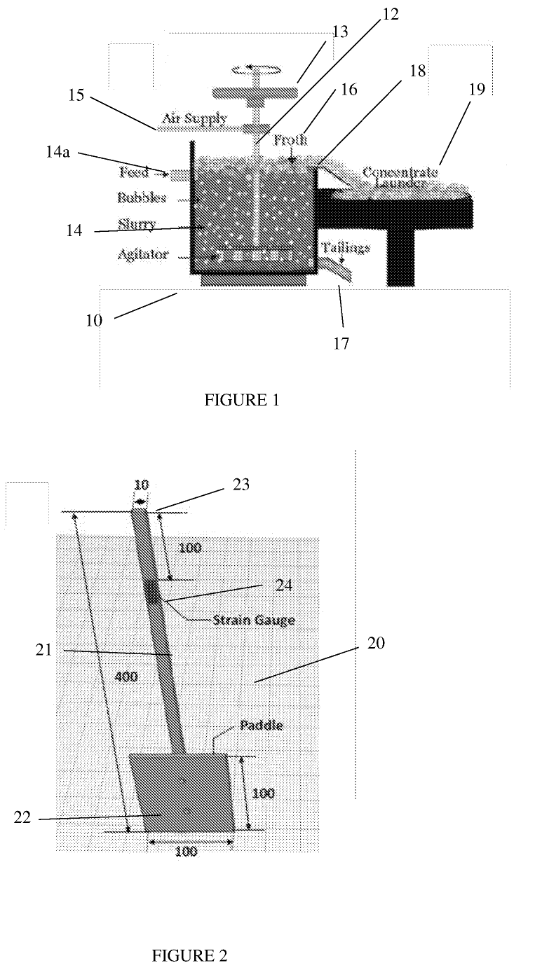

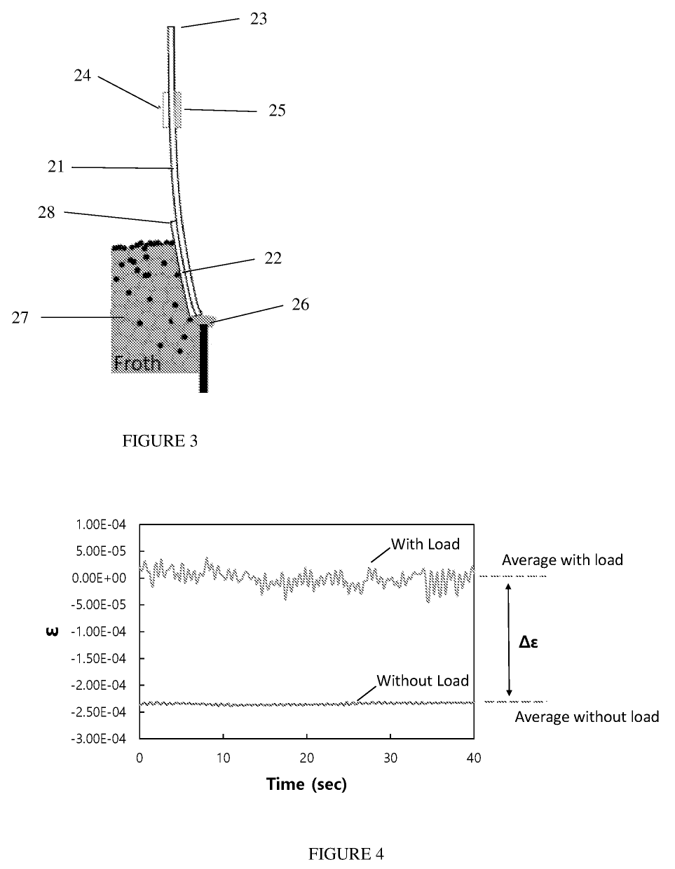

FIGS. 2 and 3 show a schematic view of an apparatus 20 in accordance with an embodiment of the present invention. The apparatus 20 comprises an arm 21 having a paddle 22 attached at one end. The arm 21 and paddle 22 may be made from two separate components that are connected together, or they may be moulded or cast together. The arm 21 suitably is made from a metal, such as a stainless steel or an aluminium. The paddle 22 may be made from a metal, such as stainless steel. Ideally, the arm 21 and paddle 22 are made from a material that does not chemically interact with the froth and is reasonably abrasion resistant. The arm 21 has an upper end 23. A first strain gauge 24 is attached to one side of the arm. A second strain gauge 25 (see FIG. 3) is attached to the other side of the arm 21.

In use, the arm 21 is fixed at its upper end to a superstructure (not shown). The arm 21 may be fixed such that the paddle 22 is located above an overflow lip 26 of a flotation vessel. A layer of froth 27 extends above the overflow lip 26 during operation of the flotation process taking place in the flotation vessel. As can be seen from FIG. 3, the upper edge 28 of the paddle 22 is located above the top edge of the froth layer 27. It is believed that this will result in more accurate monitoring in the event that the height of the froth layer changes during operation of the froth flotation process.

The apparatus shown in FIGS. 2 to 3 is a novel sensor to monitor real-time flotation performance by measuring the drag exerted by the overflowing froth onto a cantilever beam arm. When the body of the sensor is immersed into the froth, it obstructs the fluid path and experiences a drag force from the froth on the beam or arm. The drag force leads to a deflection of the cantilever beam or arm and induces a positive strain (extension) on the side facing the overflowing froth and a negative strain (compression) on the rear side of the beam arm. The strain exerted on the beam or arm can be directly correlated to the efficiency of the froth flotation process. In one embodiment, the difference in the strain exerted on the strain gauges on either side of the beam by the froth can be directly correlated to the efficiency of the froth flotation process. In some embodiments of the present invention, using the difference in strain measured by the strain gauges located on opposite sides of the arm or beam provides for a larger reading and therefore reduces the amount of noise in the signals. This, in turn, should lead to more accurate monitoring.

### EXAMPLE

Industrial test work was carried out in a coking coal preparation plant in Central Queensland, Australia. The test work was carried out using one of the column flotation cells in the plant for five days. Froth depth was fixed at 1.0 m but frother dosage and aeration rate were changed over a wide range. At each experimental condition, samples were simultaneously collected from the feed, concentrate, and tailing streams twice, with a minimum 10-minute period between the first sample collection and the second sample collection for checking the repeatability. After collection of the second sample, frother dosage rate and/or aeration rate were adjusted and a waiting period of at least 1 hour was allowed to ensure the attainment of steady state. As each of the operational variables fluctuated from its set point, the actual values while collecting the samples from the flotation cell were downloaded from the plant data acquisition system and then averaged over the time when the samples were collected.

The collected samples were transported to The University of Queensland to determine the ash content. Flotation performance was assessed by calculating flotation yield (Y) and combustible recovery (R_{comb}) using the following equations:

$$\begin{matrix}Y = \frac{{A}_{\text{T}} - {A}_{\text{F}}}{{A}_{\text{T}} - {A}_{\text{C}}} \times 100 \% \\ {R}_{\text{comb}} = Y \frac{1 - {A}_{\text{C}}}{1 - {A}_{\text{F}}} \times 100 \%\end{matrix}$$

where A_{T}, A_{F}, and A_{C} are the ash contents of the tail, feed, and concentrate, respectively.

The correlation between flotation performance and the output of the drag sensor was compared to that of a known gas holdup system (referred to as “System GH”). System GH is a differential pressure transmitter (EJX110A, Yokogawa) being used by the coal flotation plant, which was employed to measure the gas holdup in the pulp phase. As this system has been regularly calibrated by the site personnel, the gas holdup values obtained from the plant data acquisition system were used directly in the present work.

A schematic diagram of the sensor to monitor flotation performance is shown in FIG. 2. During the site trial, a hinge was applied 5 cm above the strain gauge to fix the cantilever beam. The bottom of the sensor was positioned 0.5 cm above the lip of the flotation cell, and the sensor was placed 4 cm (horizontal distance) away from the cell lip (see FIG. 3). When the body of the sensor is immersed into the fluid, it obstructs the fluid path and experiences a drag force from the fluid. The drag force leads to a deflection of the cantilever beam and induces a positive strain (i.e., extension) on the side facing the overflowing froth and a negative strain (i.e., compression) on the rear side of the beam.

The strain of the cantilever was measured directly using two strain gauges (CEA-13-240UZ-120, Vishay Micro-Measurements) attached on both sides of the beam. The strain gauges were connected with a Wheatstone half-bridge configuration to increase the sensitivity. The voltage across the Wheatstone was continuously read out using a strain gauge conditioning module (NI 9237, National Instruments) during the test. Signal Express (National Instruments) was used as a data acquisition software and the strain data were logged at a rate of five data per second.

FIG. 4 shows the typical outputs of the new sensor during the site trial. A negative strain (i.e., - 0.024%) can be found even in the absence of load, as resistances of the strain gauges across the Wheatstone Bridge arms are not equal to each other due to the inherent nature of the commercial strain gauge. As we were interested in the change in strain (Δε) caused by the overflowing froth, we used the strain output without any adjustment despite there are multiple ways to make zero strain in absence of the load, such as arbitrary addition/subtraction of resistance within the Wheatstone circuit bridge arm or manual <SHY> nulling using a strain gauge conditioning module. As shown in FIG. 4, the Δε value was obtained from the averaged signals with and without load using the following equation:

$$Δ ε = {ε}_{\text{with load}} - {ε}_{\text{without load}}$$

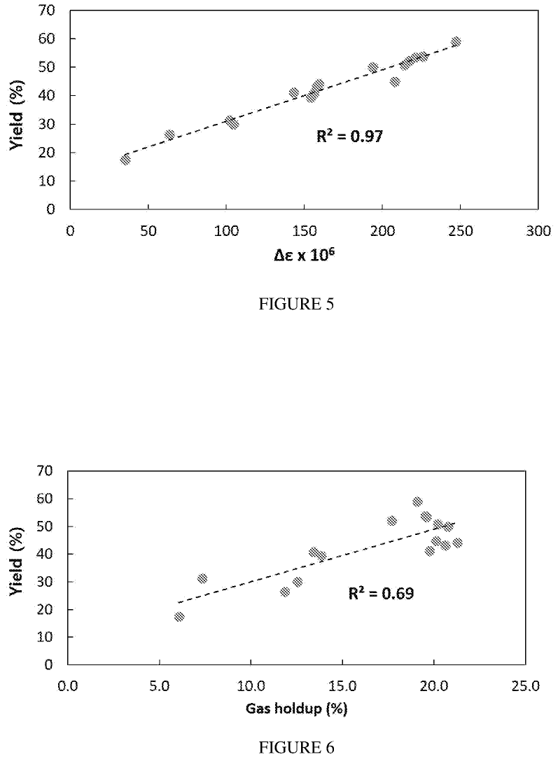

The drag sensor of the present invention was tested over a wide range of operation conditions (i.e., 0 ― 200 ml/min for frother dosing rate and 941 ― 1721 m³/hr for aeration rate), where the clean coal yield was varied from 17.5 to 59.0% and product ash content 3.5 to 8.1% during the five-day site trial. The correlations between the yield and the outputs of these two froth monitoring systems were examined and the results are shown in FIGS. 5 and 6. Apparently, the yield had a positive correlation with the drag sensor output. Linear regression was made for the experimental data shown in FIG. 5. A linear correlation was also assumed between the yield and the gas holdup of the pulp phase. As shown, the drag sensor in accordance with an embodiment of the present invention gave a very high R² value (i.e., 0.97) for the linear fit. In contrast, the value of R² of System GH was merely 0.69.

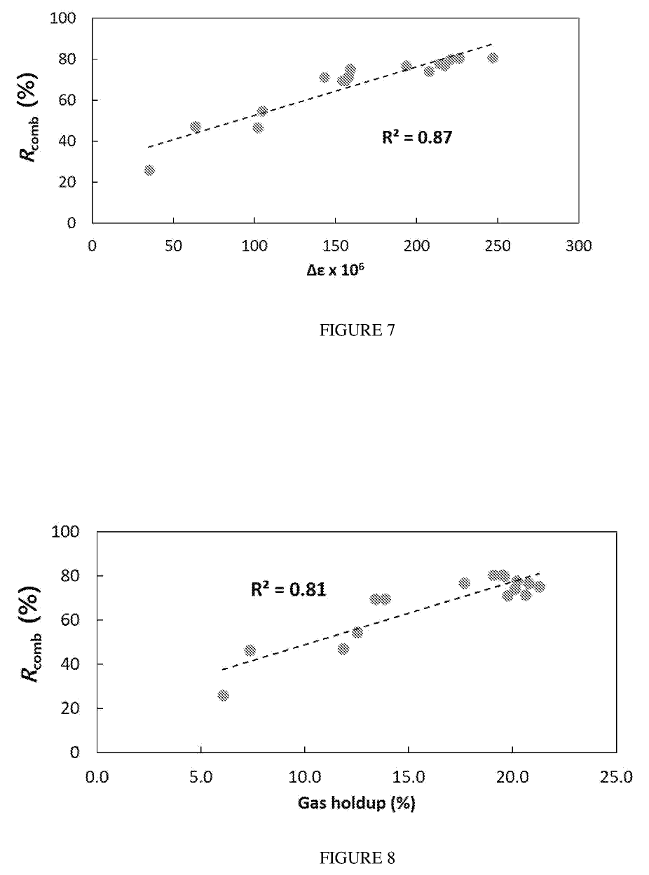

FIGS. 7 and 8 show the correlations between combustible recovery, R_{comb}, and the outputs of these two monitoring systems. During the five-day site trial, R_{comb} varied from 25.9 to 80.6%. Linear regression was made for each of these two sets of experimental data. As shown, the output of the drag sensor had a positive linear correlation with R_{comb}, with the R² of the best linear fit being 0.87, while System GH had a slightly smaller R² value (i.e., 0.81). The linear relation between the output of System GH and R_{comb} was clear when the gas holdup values were up to 14% or the combustible recovery was below 70%. It appeared that System GH lost sensitivity at flotation conditions with relatively high gas holdups at which the combustible recovery levelled off. This observation was consistent with previous findings that an increase in gas holdup improves flotation kinetics and carrying capacity of the cell up only to a certain value.

### Correlation With Flotation Recovery at Normal Operating Conditions

In the previous section, the diagnostic performance of two different systems were examined over a wide range of operating conditions by adjusting the aeration rate and/or frother dosage. In normal production, however, the flotation plant sets the aeration rate of the flotation cell at approximately 1700 m³/hr (the limit of the air compressor being used) and adjusts the frother dosage based on the feed coal quality. We, thus, evaluated the diagnostic performance of these two systems again at the normal operation conditions (i.e., frother dosage at least 170 mL/min and aeration rate at approximately 1700 m³/hr). Eight different test results obtained at the normal operating conditions in four different days were selected for the analysis. The flotation yield varied between 43.2 and 59.0%, and the combustible recovery between 71.5 and 80.6%.

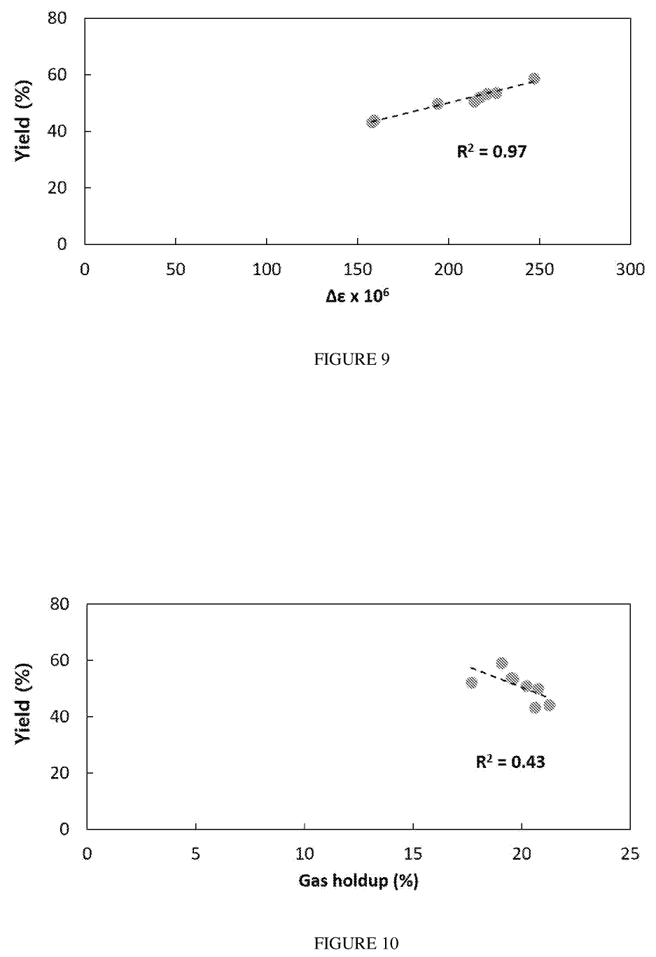

FIGS. 9 and 10 shows the correlations between flotation yield and the outputs of these two monitoring systems at the normal operating conditions, FIG. 9 for the present invention and FIG. 10 for System GH. As shown, the new drag sensor still had a very strong linear correlation with the flotation yield (R² = 0.97). In contrast, System GH lost its sensitivity, with the R² value of the best linear fit being merely 0.43.

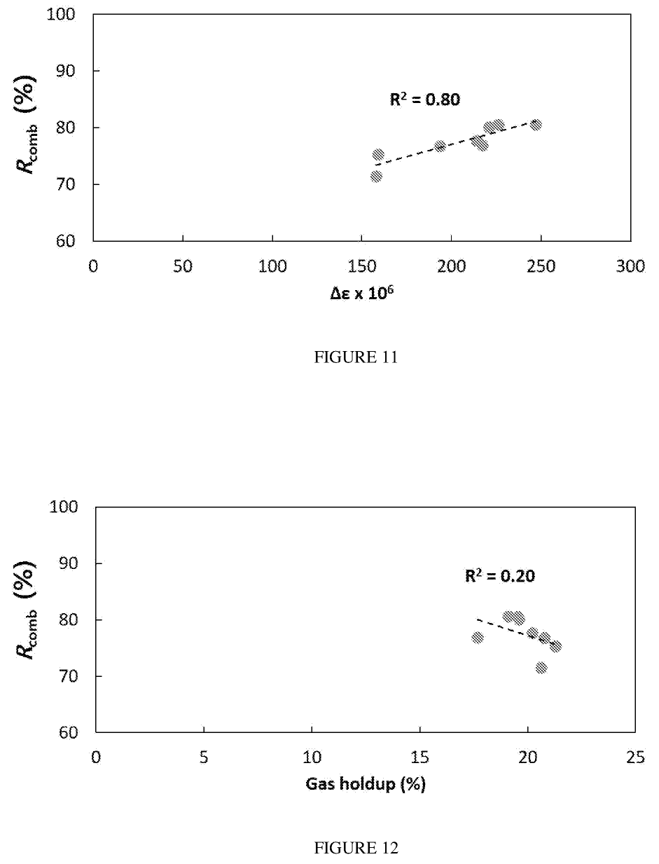

FIGS. 11 and 12 shows the correlations between combustible recovery, R_{comb}, and the outputs of these two monitoring systems at the normal operating conditions. Similarly, a strong linear correlation (R² = 0.80) can be found with the new drag sensor (FIG. 11) whereas Systems GH lost its ability to diagnose the combustible recovery with the R² value of the best linear fit being 0.20 (FIG. 12).

### Correlation With Feed Ash Content at the Normal Operating Conditions

Many coal flotation plants experience large daily variations in recovery due to variation in the feed quality but do not have real-time monitoring tools for process control and optimization. The flotation performance is primarily governed by the flotation feed quality as long as the other flotation operating condition is set constant. We, thus, examined the possibility of the newly developed sensor, originally designed for flotation performance monitoring, to detect the variation of the ash content in the flotation feed at the normal operation conditions (i.e., frother dosage at least 170 mL/min and aeration rate at approximately 1700 m³/hr), with the measured feed ash contents falling in the range of 32.0 ― 46.0%.

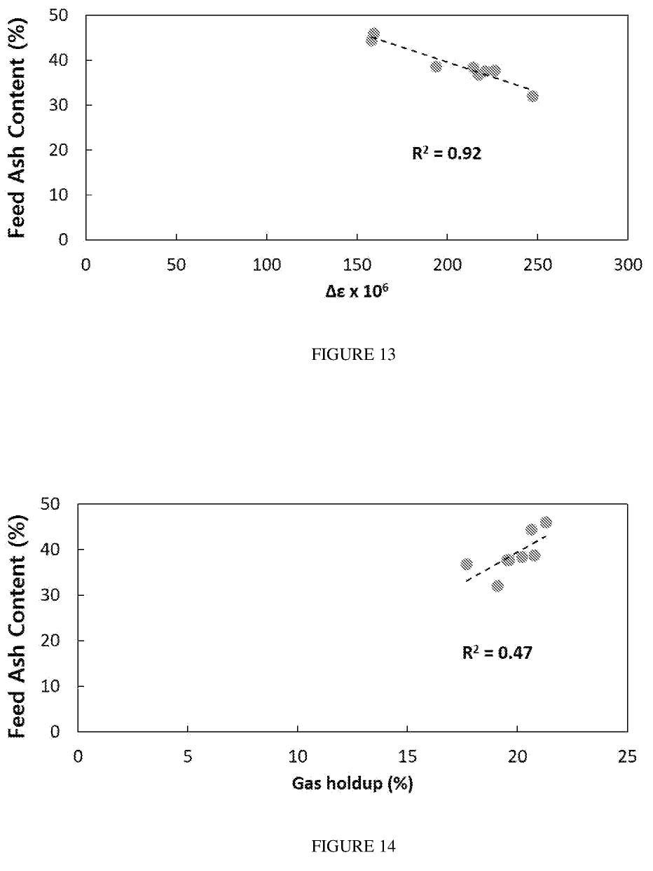

FIG. 13 shows the feed ash content plotted against the drag sensor output and the gas holdup. A very strong correlation (R² = 0.92 for the best linear fit) existed between the feed ash content and the output of the new drag sensor. System GH had a low R² value (i.e., 0.47) again. The result suggested that the drag sensor in accordance with the present invention could also be used to monitor feed ash content variation when other operation variables are set almost constant.

The results obtained in the present work suggested that there was a strong linear correlation between the output of the drag sensor and the yield (mass recovery). In the present study, a simple and economical drag sensor for monitoring flotation performance was developed and demonstrated at industrial scale. The new sensor was made from a cantilever beam and two strain gauges. The sensor was installed above a large industrial column flotation cell, and its diagnosis ability was tested at a wide range of the flotation operation conditions (by adjusting frother dosage and aeration rate). For comparison, experimental data were collected simultaneously from System GH based on gas holdup measurement. At a wide range of the flotation operation conditions, the sensor had stronger linear correlations with clean coal yield (mass recovery) and the combustible recovery compared to those of System GH. At the normal flotation operation conditions of the plant, only the drag sensor could diagnose the variations in the yield and combustible recovery while the System GH lost its sensitivities. It was also found that the drag sensor, which was originally designed for flotation performance monitoring via monitoring the froth properties, enabled instant detection of the variation of the feed ash content when other operation conditions were set almost constant. The sensor can be used as a low-cost stand-alone device to help monitor flotation performance online and provide instant feedback for process optimization and control.

The optimisation of the froth flotation process could result in an increase in the yield of coal/minerals, leading to significant increase in operating profits for the mining industry. The simple and economical design of the apparatus of the present invention, along with its high accuracy compared to the existing measurement techniques, should improve the economics of froth flotation plant operation.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An apparatus for monitoring flotation performance, the apparatus comprising a drag member positionable to allow froth of a froth flotation operation to contact the drag member, and a sensor for determining a drag force or a parameter associated with the drag force provided on the drag member by the froth.

2. An apparatus as claimed in claim 1 wherein the froth contacts the drag member and the froth flows around and past the sensor, or the drag member is positioned such that it is positioned in a flow of froth overflowing a froth flotation vessel.

3. An apparatus as claimed in claim 1 wherein the sensor provides a signal associated with the drag force provided on the drag member.

4. An apparatus as claimed in claim 3 wherein the signal is provided to a monitoring system or a control system.

5. An apparatus as claimed in claim 1 wherein the drag member comprises an arm or a cantilever arm being fixed at one end.

6. An apparatus as claimed in claim 1 wherein the sensor senses deflection of the arm.

7. An apparatus as claimed in claim 1 wherein the sensor comprises one or more strain gauges attached to the arm, or the sensor comprises a deflection measurement sensor that measures deflection of the arm, or the sensor comprises a visual sensor that uses image processing technology to measure deflection of the arm, or a laser-based optical deflection method with high-sensitivity position-sensitive detector.

8. An apparatus as claimed in claim 1 wherein the sensor generates an electrical signal in response to deflection of the arm.

9. An apparatus as claimed in claim 1 wherein the sensor comprises a strain gauge mounted to one side of the arm, or the sensor comprises at least one strain gauge mounted on one side of the arm and at least one other strain gauge mounted on the other side of the arm.

10. An apparatus as claimed in claim 1 wherein the drag member comprises a paddle or a plate mounted to an arm or formed with the arm.

11. A method for monitoring a froth flotation operation, the method comprising mounting a drag member such that froth in the froth flotation operation applies a drag force to the drag member, and measuring the drag force or determining a parameter associated with the drag force applied to the drag member.

12. A method as claimed in claim 11 wherein the method further comprises transmitting a signal indicative of the drag force or indicative of the parameter associated with the drag force to a control system or monitoring system.

13. A method as claimed in claim 11 wherein the method further comprises correlating the drag force or the parameter associated with the drag force with flotation performance.

14. A method as claimed in claim 11 wherein the method comprises providing a drag member comprising a paddle or a plate mounted to or formed with an arm, mounting the drag member in a fixed position such that the paddle or plate is located partly within a froth layer, wherein the froth overflowing the lip applies a drag force to the paddle or plate.

15. A method as claimed in claim 14 wherein the drag member is mounted in a fixed position such that the paddle or plate is located partly within a froth layer overflowing an overflow lip of a froth flotation vessel.

16. A method as claimed in claim 11 wherein the method comprises measuring the drag force or determining a parameter associated with the drag force applied to the drag member at a certain time, taking a sample of the froth at that certain time and analysing the sample of the froth at that certain time to determine froth flotation performance at that certain time, and repeating those tests at spaced times, and obtaining a correlation between the drag force or the parameter associated with the drag force and froth flotation performance.

17. A method as claimed in claim 11, wherein the method is a method for controlling a froth flotation operation, the method further comprising correlating the drag force or the parameter associated with the drag force with flotation performance and adjusting operation of the froth flotation operation in response to changes in flotation performance.

18. A method as claimed in claim 11, wherein the method is a method for determining ash content of coal in a flotation process, the method further comprising calculating an ash content from the measured drag force or from the parameter associated with the drag force.

19. A method as claimed in claim 18 comprising taking a sample of coal in the froth, measuring the drag force or determining a parameter associated with the drag force applied to the drag member at the time that the sample was taken, repeating these steps over a period of time, analysing the samples for ash content in the coal and determining a correlation between the analysed ash content and the measured drag force or parameter, and subsequently determining ash content by measuring the drag force or determining a parameter associated with the drag force applied to the drag member and using the correlation to determine the ash content associated with the measured drag force or parameter and wherein other operating conditions in the flotation process are held substantially constant during these measurements, or the other operating conditions in the flotation process are held at or near normal operating conditions during these measurements.

20. A method as claimed in claim 18 wherein other operation conditions in the flotation operation are held almost constant or the other operating conditions in the flotation process are held at or near normal operating conditions in order to obtain accurate ash content determinations.
